(19) United States
(12) Patent Application Publication
(10) Pub. No.: US 2010/0039514 A1
(43) Pub. Date: Feb. 18, 2010

(54) System and Method for Image Projection of Operator Data From An Operator Control Unit

(76) Inventor: John Brand, Melbourne, FL (US)

Correspondence Address: BEUSSE WOLTER SANKS MORA & MAIRE, P.A., 390 NORTH ORANGE AVENUE, SUITE 2500, ORLANDO, FL, 32801, US

(21) Appl. No.: 12/191,371

(22) Filed: Aug. 14, 2008

(51) Int. Cl. H04N 7/18; G06F 17/00; H04N 9/31; G01C 21/00

(52) U.S. Cl. 348/148; 701/2; 701/207; 348/744; 348/E07.085; 348/E09.025

(57) ABSTRACT

A system is provided for projecting images of operator data from an operator control unit. The system includes an imaging device configured to collect and transmit one or more visual images of a portion of a locomotive (or other vehicle) or an area surrounding the locomotive. In addition, the system includes an off-board operator control unit configured to receive the one or more visible images from the imaging device and comprising a projector configured to project the received one or more images onto a substrate. Additionally, a method for projecting images of operator data from an operator control unit is provided.

### FIELD OF THE INVENTION

The present invention relates to a system and method for imaging data, and more particularly, to a system and method for projecting images of operator data from an operator control unit.

### BACKGROUND OF THE INVENTION

Classification yards are used in rail transportation environments to sort freight cars onto different track sections depending on each freight car's destination after leaving the yard. Yard switching refers to the transfer of a freight car or freight cars from one track to another within the yard, typically with the intent of assembling a train bound for a common destination. In the past, the switching of trains in a rail yard required a “switchman” on the ground at each end of the train to properly align the tracks and an engineer in a cab of a locomotive of the train in communication with the switchman for moving the train down the desired tracks according to the switchman's instructions. More recently, locomotives equipped with remote control systems (RCL's) have allowed the switchman to control the movement of the locomotive in the yard without the aid of an engineer. Instead, the movement of the locomotive may be controlled via an on-board Locomotive Control Unit (LCU) using a battery-powered portable Operator Control Unit (OCU) carried by the switchman located adjacent to, but off-board of the locomotive to be controlled.

Known OCU devices may include a simple display unit (e.g., an LCD unit) for displaying information to the operator, which may be in the form of a graphical user interface (GUI) display. In particular, the display panel typically displays system operating messages in an alphanumeric format, including OCU status information, warnings, alerts, current condition of locomotive on-board systems, and troubleshooting information. One problem associated with known OCU devices, particularly ones having LCD displays, is that the data conveyable to the operator is typically limited to functional language. Moreover, it is known that the delivery of information to the LCD is particularly affected by cold weather. In such an environment, the speed of transmission to the OCU may be notably slow. Moreover, in especially cold weather, the LCD screens may not even be visible to the operator.

In addition, the Federal Railroad Association currently mandates that the movement of a RCL in a rail yard requires point-protection. In other words, the engineer moving the train via the LCU and OCU must be able to visually determine for the duration of the shoving or pushing movement that the track is clear within the range of vision for the complete distance to be shoved or pushed. Presently, this is performed by a number of different methods, including but not limited to, the movement of the locomotive within RCL zones having RFID tags to determine the location of the locomotive. The RFID tags on the track act as speed posts for the train to slow down, but provide zero line-of-sight from the operator. Further, the RFID tags must be set up prior to the arrival of the locomotive and, once the locomotive is out of the zone, the RCL zones must be set up again, thereby resulting in the significant expenditure of manpower, time, and expense. Even further, RFID tags are known to tear easily and often need to be replaced.

### BRIEF DESCRIPTION OF THE INVENTION

One embodiment of the present invention provides a system for viewing information associated with a locomotive or other vehicle. The system includes an imaging device configured to collect and transmit one or more visual images of a portion of the locomotive or other vehicle or an area surrounding the locomotive. The system further includes an off-board operator control unit configured to receive the one or more visual images from the imaging device. In addition, the operator control unit comprises a projector configured to project the received one or more images onto a substrate. By “substrate,” it is meant a surface capable of receiving a projected image for viewing the content of the projected image. Also, by “off-board,” it is meant that the operator control unit is not on the locomotive or other vehicle.

Another embodiment of the present invention provides a system for viewing information in a rail yard or other location where vehicles are marshaled, organized, switched, or dispatched. The system includes a dispatcher for storing information and/or obtaining information from an external source, the dispatcher comprising a processor and a transceiver, a dispatcher for storing information and/or obtaining information from an external source, said dispatcher comprising a processor and a transceiver. The system further includes an off-board operator control unit for remote control of a locomotive or other vehicle configured to receive the information sent from the transceiver and a projector configured to project the received information onto a substrate.

Yet another embodiment of the present invention provides a method for viewing information associated with a locomotive or other vehicle. The method includes collecting one or more visual images of a portion of the locomotive or other vehicle or an area surrounding the locomotive or other vehicle. The method further includes transmitting the collected one or more visible images to an off-board operator control unit and projecting the one or more visual images from the operator control unit onto a substrate.

Still another embodiment of the present invention provides a method for projecting information in a rail yard or other location where vehicles are marshaled, organized, switched, or dispatched. The method includes transmitting data representative of at least one of a first information and a second information from a dispatcher to an off-board operator control unit remote from the dispatcher. The dispatcher has the first information stored in a memory therein and/or collects the second information from a source remote from the dispatcher. In addition, the dispatcher comprises a processor and a transceiver. The method further comprises projecting a visual representation of at least one of the first and second information from the operator control unit.

### BRIEF DESCRIPTION OF THE DRAWINGS

A more particular description of the embodiments of the invention briefly described above will be rendered by reference to specific embodiments thereof that are illustrated in the appended drawings. Understanding that these drawings depict only typical embodiments of the invention and are not therefore to be considered to be limiting of its scope, the embodiments of the invention will be described and explained with additional specificity and detail through the use of the accompanying drawings in which:

FIG. 1 is a schematic illustration of an exemplary embodiment of a system for projecting images from an OCU according to the present invention;

FIG. 2 is a schematic illustration of another exemplary embodiment of a system for projecting images from an OCU according to the present invention;

FIG. 3 is a schematic illustration of yet another exemplary embodiment of a system for projecting images from an OCU according to the present invention;

FIG. 4 is a schematic illustration of still another exemplary embodiment of a system for projecting images from an OCU according to the present invention;

FIG. 5 is a schematic illustration of still another exemplary embodiment of a system for projecting images from an OCU according to the present invention;

FIG. 6A is a cross-sectional view of an interior of an OCU having a selectively adjustable mirror in a first position to project an image onto a substrate remote from the OCU according to the present invention;

FIG. 6B is a cross-sectional view of an interior of an OCU having a selectively adjustable mirror in a second position to project an image onto a substrate on the OCU according to the present invention;

FIG. 7 is a flow chart illustrating an exemplary embodiment of a method for viewing information associated with a locomotive according to the present invention; and

FIG. 8 is a flow chart illustrating an exemplary embodiment of a method method for projecting information in a rail yard according to the present invention.

### DETAILED DESCRIPTION OF THE INVENTION

In describing particular features of different embodiments of the present invention, number references will be utilized in relation to the figures accompanying the specification. Similar or identical number references in different figures may be utilized to indicate similar or identical components among different embodiments of the present invention.

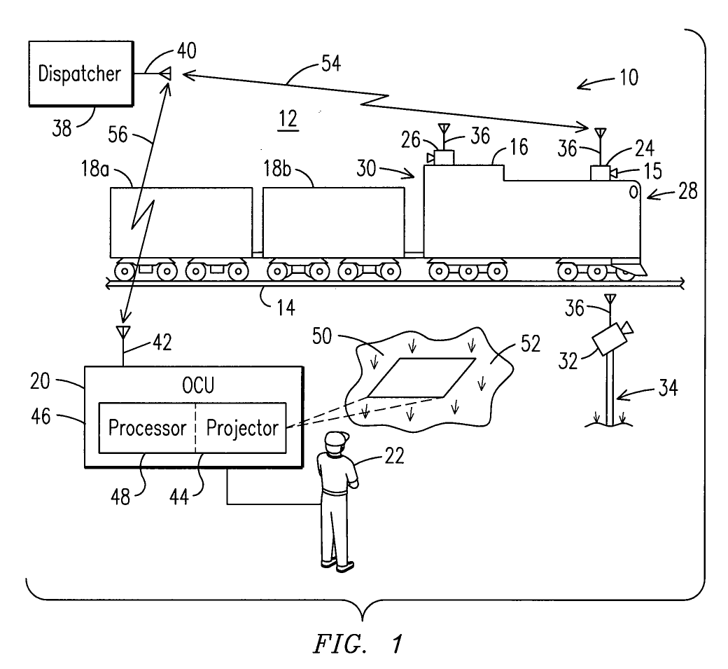

Now referring to the figures, FIG. 1 illustrates an embodiment of a system 10 for imaging data in a typical train depot or rail yard 12. As will be appreciated by those skilled in the art, the rail yard 12 may comprise a large number of interconnectable railtracks 14, which are connectable through the activation of switches (not shown) to a suitable switching state. In the embodiment shown, the system 10 includes a train having a locomotive 16 and a plurality of train cars 18a, 18b connected thereto, an imaging device 15 located on or about the locomotive 16, and an Operator Control Unit (OCU) 20, typically held by an operator 22 off-board, i.e. remote, from the locomotive 16.

The imaging device 15 may comprise one or more video cameras, such as a forward looking camera 24 and a rearward looking camera 26 as shown, which are positioned on a desired internal or external location on the locomotive 16. In one embodiment, the cameras 24, 26 are located at a respective long hood portion 28 of the locomotive 16 and a short hood portion 30 of the locomotive 16. Alternatively, the cameras 24, 26 may be located on any portion of the locomotive 16, which are effective to provide a view of the locomotive 16 or an area about the locomotive 16 or train cars 18a, 18b. Alternatively or in addition to, it is contemplated that one or more wayside cameras 32 may be located at a wayside location 34 of the locomotive 16 to provide a view of the locomotive 16, an area about the locomotive 16 or train cars 18a, 18b, an area within the rail yard 12, or any other desired location. Each of the cameras 24, 26, 32 typically includes a transmitter or transceiver 36 located thereon to transmit real-time or near real-time visual images, and optionally audio information, directly or indirectly to the OCU 20 as set forth below via a wireless or direct communication. In one embodiment, any one or more of the cameras may comprise an audio and visual recording system sold under the trademark LocoCAM™, available from General Electric Transportation Systems, Schenectady, N.Y.

In one embodiment, the system further includes a dispatcher 38 having a transceiver 40 for receiving and transmitting the visual information and audio information (if any) from any of the cameras, such as cameras 24, 26, and 32. The dispatcher 38 includes a microprocessor and a memory (not shown) and may store any desired information therein, including the audio and/or visual information sent from any of the cameras described above and relay the information to the OCU 20. In addition, the dispatcher 38 may store information such as yard track layouts, switch positions, cut lists, and the like, or be in communication with databases or devices providing such information or other information. The dispatcher 38 may then relay such received or stored information to the OCU 20. Alternatively, information from a suitable storage medium may be accessed by the dispatcher 38 and then delivered to the OCU 20 in real-time or near real-time.

In the embodiment shown in FIG. 1, the OCU 20 includes a transceiver 42, mounted thereon or housed therein for transmitting and/or receiving information, and a projector 44, which projects information transmitted to the OCU 20 for viewing by the operator 22 of the OCU 20. Typically, the OCU 20 is worn or held by the operator 22, e.g., a switchman, in the rail yard 12 at a location remote from, i.e. offboard, of the locomotive 16. In an embodiment, the projector 44 projects operator data, such as images 50 sent from cameras or other information, onto a desired substrate for viewing. The substrate may be any suitable flat or curved surface, such as a ground area adjacent the operator (ground 52), a side of a building, the side of the locomotive 16 or a train car 18a, 18b, or a wayside display. Alternatively, the substrate may be a display unit on or otherwise associated with the OCU 20.

In an embodiment, the projector 44 is disposed within a housing 46 of the OCU 20. The housing 46 may be formed from any suitable relatively rigid and weatherproof material, such as plastic, or the like. When the projector 44 is disposed within the housing 46, the projector 44 is advantageously protected from freezing/cold temperatures, wind, rain and the like. In this way, the projector 44 will produce a clear image of the information displayed from the projector 44 regardless of the external environment of the OCU 20. The OCU 20 may further include a microprocessor 48, memory, a user interface and input interface such as a touchpad (not shown). The processor 48 may be in communication with the projector 44 to control the projection of the image from the projector 44, e.g., the image output, duration, and orientation of the image. The user interface and touchpad enable the operator to select the particular cameras, camera information, or other information he or she wishes to view via the projector 44 as set forth herein. The user interface may also include a controller for controlling the angle of any one of the cameras 24, 26, 32, for example. Further, in an embodiment, the OCU 20 may include one or more speakers for amplifying audio information transmitted to the OCU.

In one particular embodiment, the projector 44 comprises a microelectromechanical systems (MEMS)-based laser projector. MEMS-based projectors utilize color projectors that are modulated at nanosecond rates and a single mirror that can rotate biaxially. The single mirror creates an image by modulating the lasers of the projector pixel by pixel. In addition, the mirror, which may include metal on silicon, is configured to resonate at a particular frequency so that one axis of rotation scans quickly while the other axis of rotation is driven slowly. Collectively, they bob and weave to scan images at video rates. In an embodiment, the MEMS-based projector comprises an integrated photonics module (IPM), such as an IPM available from Microvision, Inc., Redmond, Wash. Typically, the IPM comprises a MEMS scanner and electronics to drive the MEMS scanner. An IPM typically includes a light source module, electronics to drive a video input and output, a system controller, and a buffer memory component of the IPM. The IPM may be embedded into the projector 44 of the OCU 20 to project an image 50 from the OCU 20 onto any suitable substrate, such as the ground 52 as shown in FIG. 1.

Advantageously, the image projected from a MEMS-based projector remains focused at any distance from the projector and does not produce color break-up if the projector is moved because the colors of each pixel are created simultaneously. Further advantageously, the projected image 50 from the projector 44 may be displayed on any surface, including but not limited to curved surfaces, and include notably brilliant, saturated colors, from spectrally-pure lasers that provide exceptional contrast. As a result, the projected image 50 from the OCU 20 is clear and easy to view regardless of the environment where the OCU 20 is located. In addition, the projected image 50 is not limited by display type, character space, temperature range, and update rate.

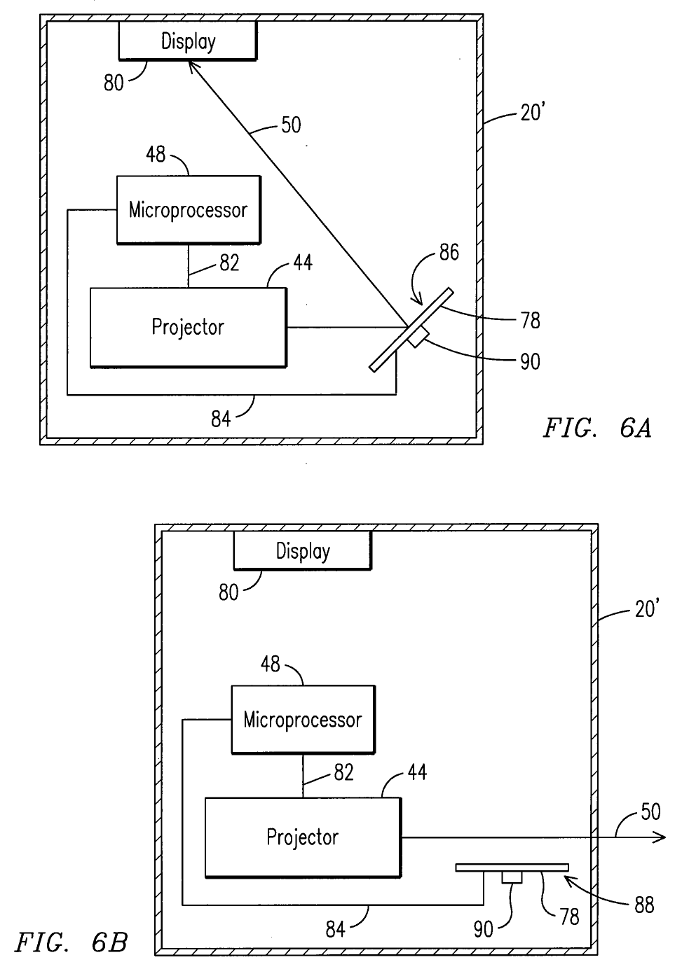

In a particular embodiment, as shown in FIGS. 6A and 6B, the OCU 20′ can display the image 50 on a substrate (display 80) associated with the OCU 20′ without the need for any significant additional power. As shown in FIG. 6A, the OCU 20′ may comprise the microprocessor 48, the projector 44, one or more mirrors, e.g., mirror 78 as shown, and a display 80. As shown by lines 82, 84, the microprocessor 48 may be in communication with the projector 44 and the mirror 78 to control the projection of the image 50 from the projector 44, e.g., the image output, duration, and orientation of the image as well as the movement of the mirror 78. The display 80 may be any material suitable for displaying the image 50 reflected from the mirror 78, such as a translucent material.

In operation, as shown in FIG. 1, an operator 22 is shown as being positioned in a rail yard 12 between adjacent train cars 18a, 18b. The train car 18b, for example, may be cut or disconnected from the locomotive 16 and train car 18a pursuant to a particular cut-list. Once the train car 18b has been disconnected, the operator 22 may control the movement of the locomotive 16 and the train car 18a via the OCU 20 and an LCU (not shown) of the locomotive 16. The LCU is typically in communication with the OCU 20 and is operable to control the locomotive 16 in response to manipulation of the OCU 20 by the operator 22. (In effect, the OCU 20 is a remote control unit for controlling the locomotive.)

When the operator 22 desires to monitor, for example, a view of the long hood portion 28 of the locomotive 16, for example, the operator may prompt the OCU 20 via the user interface on a display of the OCU 20 to provide a view of the long hood portion 28 of the locomotive. The forward looking camera 24 located at the long hood portion 28 of the locomotive 16 may gather visual and/or audio information and transmit the visual and/or audio information via the transceiver 36 located on the camera 24 to the transceiver 40 located at or on the dispatcher 38 in near real-time as indicated by reference numeral 54. The dispatcher 38 may then communicate the information to the transceiver 42 located on the OCU 20 as indicated by reference numeral 56.

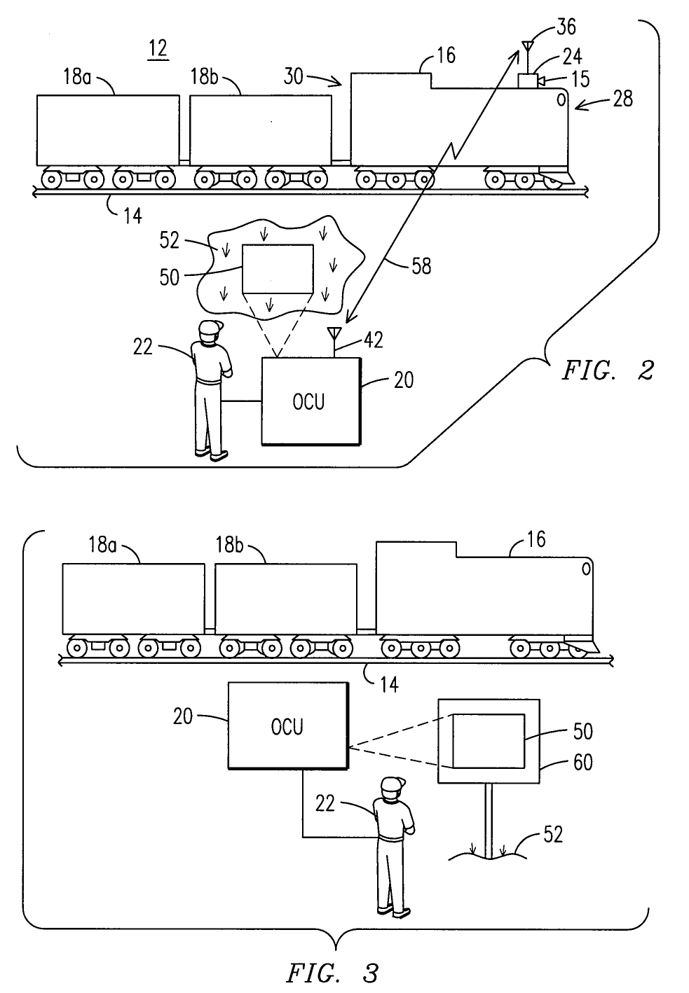

Alternatively, as shown in FIG. 2, any of the cameras, e.g., forward looking camera 24, may instead transmit real-time or near real-time visual and/or audio information directly to the OCU 20 rather than routing the information through the dispatcher 38. In this embodiment, the visual and/or audio information is transmitted from the transceiver 36 located on camera 24, for example, directly to the transceiver 42 of the OCU 20 as indicated by reference numeral 58. Thereafter, the image 50 may be projected onto a suitable substrate as set forth herein.

When the operator 22 desires to view real-time images from the front of the locomotive 16 or long hood portion 28 thereof, the operator 22 may project an image 50 taken from the forward looking camera 24 onto any suitable substrate, such as the ground 52 as shown. In the same way, real-time or near real-time visual images and audio information, if desired, may be projected from cameras 26, 32, any other wayside camera, or any camera mounted on the locomotive 16. Alternatively, as shown in FIG. 3, the operator 22 may project the image 50 from the projector 44 onto a display board 60, which is removably or permanently installed within the ground 52 adjacent to the operator 22 for viewing of the image 50. In an embodiment, the display board 60 comprises a hooded screen (not shown) that renders the image 50 particularly easy to view, even in a sunny environment.

In another embodiment, the display board 60 may include an LCD or TFT (thin-film transistor) display where message information or other information are displayed prior to or after the operator views the projected image 50. Further alternatively, the image 50 may be projected onto a side of an adjacent building, a portion of the locomotive 16 or train cars 18a, 18b, a display on or associated with the OCU 20, or alternatively on any other desired substrate.

In still another embodiment, the image 50 may be projected onto a substrate, e.g., display 80 as set forth below, that is located on, electrically connected to, or otherwise associated with the OCU 20. In this embodiment, information received by the transceiver 42 may be projected onto a display without projecting the image 50 from the projector 44 to a location remote or off-board from the OCU 20. Instead, the projector 44 will create a full-color, bright image of the information on the display as the information is received by the transceiver 42 in near real-time. It is contemplated that providing a display associated with the OCU 20 may require additional battery power greater than is required for the OCU 20 device without a display.

As shown in FIGS. 6A and 6B, the image 50 may be projected onto a display 80 associated with an OCU 20′. In this embodiment, the mirror 78 is selectively movable between a first position 86 as shown in FIG. 6A to a second position 88 as shown in FIG. 6B. In the first position 86, the mirror 78 is not in alignment with the image 50 being projected from the OCU 20′ such that the image 50 may be projected onto a substrate remote from the OCU 20′, e.g., the ground 52, a side of a building, train car, etc. as set forth herein. In the second position 88, the mirror 78 is pivoted such that the image 50 projected from the projector 44 is now deflected by the mirror 78 from the projector 44 to the display 80 on the OCU 20′ itself. The projected image 50 may then be easily viewed by the user of the OCU 20′.

In an embodiment, as shown in FIG. 6B, the mirror 78 may include one or more sensors 90 for sensing an orientation of the projected image 50. Optionally, based on the information conveyed to the microprocessor 48 by the one or more sensors 90, the microprocessor 48 can cause the projected image 50 to be inverted or otherwise oriented in the configuration necessary to display the image in the proper-readable position on the display 80 of the OCU 20′ or other substrate remote from the OCU 20′. Via a user interface or touchpad associated with the OCU 20′, the user may selectively choose between viewing the image on the display 80 of the OCU 20′ or alternatively on a substrate remote from the OCU 20′. In an alternate embodiment, the OCU 20′ may comprise a single mirror in a fixed position to cause the image 50 to be displayed only on the display 80 of the OCU 20′ permanently.

Once the projector 44 projects the particular image 50, the image 50 may be projected for as long as is necessary or desired for the operator 22 to complete the task for which the viewing of the projected image 50 is needed, such as for reviewing a cut-list or switch list, verifying automated switches, moving the locomotive 16 forward on the tracks as needed, and the like.

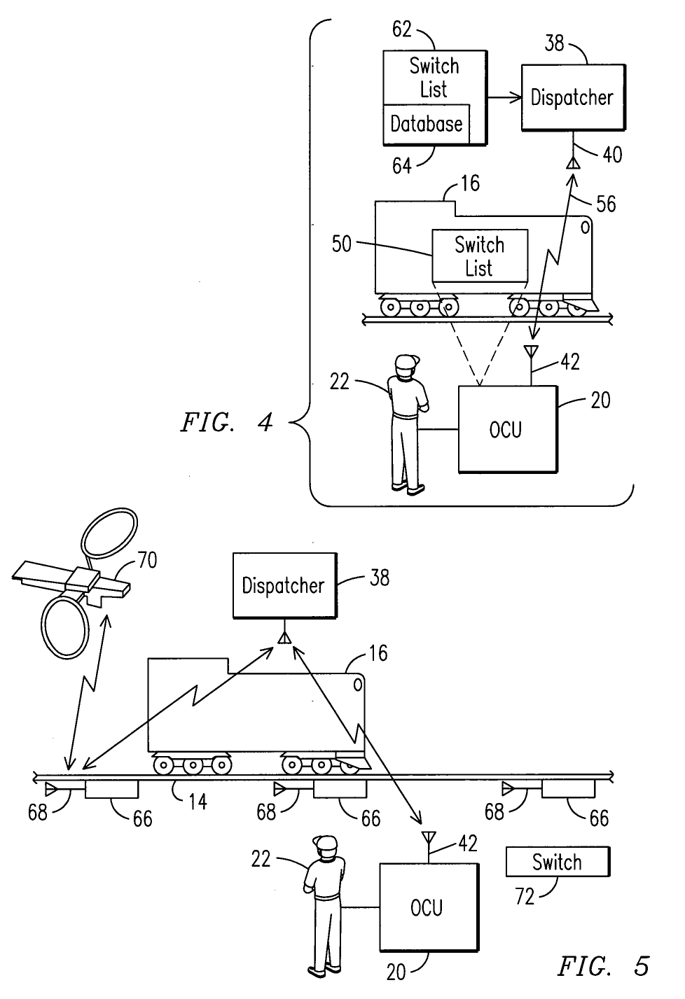

In addition, using the novel OCU 20, the operator 22 may project any other information useful for accomplishing a particular task in the rail yard. In one embodiment, for example, as shown in FIG. 4, the projected image 50 may be a switch list 62 or other information for the regulation of switching activities in a rail yard environment. The operator 22 may project the switch list 62 onto a substrate for easy viewing of the switch list 62. To accomplish this, the dispatcher 38 may include one or more switch lists, e.g., switch list 62, stored within its memory. Alternatively, the dispatcher 38 may be in communication with a database via the Internet or a suitable network. Once the switch list 62 is conveyed from the dispatcher 38 to the OCU 20 via the transceivers 40, 42, the OCU 20 may display the switch list 62 on an area of ground 52, onto a display board 60, on a side of the locomotive 16 where the operator 22 with the OCU 20 is present (as in FIG. 4), or on any other desired substrate as set forth herein. Alternatively, any other desired information related to the locomotive (in addition to switch lists) may be stored in the memory of the dispatcher 38 or an associated database, which may be readily communicated from the dispatcher 38 to the OCU 20 via transceivers 40, 42 and projected onto a suitable substrate.

Communication (each way) between any of the cameras 24, 26, 32, and the OCU 20, between the dispatcher 38 and the OCU 20, the cameras 24, 26, 32 and the dispatcher 38, and/or between the database 64 and the dispatcher 38 may be accomplished by radiofrequency (RF) communication or other suitable communication system. RF communication works by creating electromagnetic waves at the source and picking up those electromagnetic waves at a particular destination. These electromagnetic waves travel through the air at near the speed of light. The wavelength of an electromagnetic signal is inversely proportional to the frequency; the higher the frequency, the shorter the wavelength. * In an embodiment of the system 10 having RF communication capability, the frequency and wavelength may be adjusted to transfer information within a certain amount of time, i.e. the data rate, and cover a particular transmission distance.

In an additional embodiment, the system 10 is configured to automatically provide useful information, including switching information, switch lists, track layouts, and image data (from cameras 24, 26 and 32 for example) corresponding to a location of the locomotive 16 in the rail yard 12. In a particular embodiment, as shown in FIG. 5, the tracks 14 may include a plurality of sensors 66 for sensing a particular location of the locomotive 16. The sensors 66 may each include, for example, a transceiver 68 in communication with one or more global positioning system (GPS) satellites 70. Thus, when for example, the locomotive 16 is positioned 100 feet from a particular switch 72, one or more of the GPS satellites 70 may transmit information to the transceiver 68 of one or more of the sensors 66 indicating the presence and location of the locomotive. The sensors 66 optionally confirm the presence of the locomotive 16 and may thereafter transmit a signal to the dispatcher 38 indicating the presence of the locomotive 16. In response, the dispatcher 38 may transmit information related to the particular location of the locomotive 16, such as a suggested list of the particular cameras to view, switching information, tracking information, and the like to the OCU 20 as previously described herein. In addition, the operator 22 may view this information by projecting an image 50 representative of the information on a suitable substrate as set forth herein.

Besides locomotives and other rail-based vehicles, embodiments of the present invention are also applicable for use in the context of other off-highway vehicles (OHV) and other vehicles generally. “Off-highway vehicle” refers to non-passenger vehicles such as locomotives and other railroad power units, other rail vehicles, mining trucks or other construction or excavation vehicles, agricultural vehicles, and the like. Typically, embodiments of the invention will be implemented in rail yards or in other locations where vehicles are marshaled, organized, switched, and/or dispatched.

Although embodiments 6f the invention have been described as including MEMS-based projectors, other types of projector units may also be acceptable, such as small, portable digital/LCD projectors of the type often used for business presentations.

Based on the foregoing specification, the above-discussed embodiments of the invention may be implemented using computer programming or engineering techniques including computer software, firmware, hardware or any combination or subset thereof, wherein the technical effect is to project images of operator data from an operator control unit. Any such resulting program, having computer-readable code means, may be embodied or provided within one or more computer-readable media, thereby making a computer program product, i.e., an article of manufacture, according to the discussed embodiments of the invention. The computer readable media may be, for instance, a fixed (hard) drive, diskette, optical disk, magnetic tape, semiconductor memory such as read-only memory (ROM), etc., or any emitting/receiving medium such as the Internet or other communication network or link. The article of manufacture containing the computer code may be made and/or used by executing the code directly from one medium, by copying the code from one medium to another medium, or by transmitting the code over a network.

One skilled in the art of computer science will easily be able to combine the software created as described with appropriate general purpose or special purpose computer hardware, such as a microprocessor, to create a computer system or computer sub-system of the method embodiment of the invention. An apparatus for making, using or selling embodiments of the invention may be one or more processing systems including, but not limited to, a central processing unit (CPU), memory, storage devices, communication links and devices, servers, I/O devices, or any sub-components of one or more processing systems, including software, firmware, hardware or any combination or subset thereof, which embody those discussed embodiments of the invention.

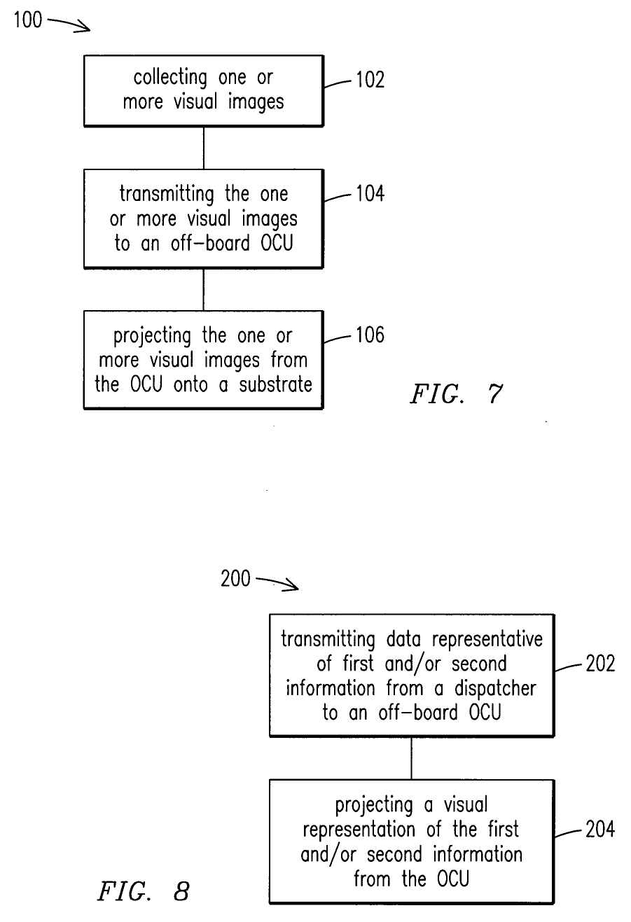

In accordance with another aspect of the present, FIG. 7 illustrates a method 100 for viewing information associated with a locomotive or other vehicle. The method begins by collecting 102 one or more visual images 50 of a portion of the locomotive 16 or other vehicle or an area surrounding the locomotive 16 or other vehicle. The method further comprises transmitting 104 the one or more visual images to an off-board operator control unit 20. Next, the method comprises projecting 106 the one or more visual images 50 from the operator control unit 20 onto a substrate as described herein. In an embodiment, the one or more visual images 50 are collected from one or more cameras, e.g. cameras 24, 26, located on a portion of the locomotive 16 or other vehicle. In another embodiment, the one or more visual images 50 are collected from a wayside camera, e.g. camera 32.

Typically, the projecting is performed by an operator 22 holding the operator control unit 20 at a location off-board from the locomotive or other vehicle. As set forth herein, the one or more visual images 50 may be projected onto any suitable substrate, e.g. a surface capable of receiving a projected image for viewing the content of the projected image. In one embodiment, the operator control unit projects the one or more visual images onto a ground area 52 adjacent an operator 22 holding the operator control unit 20. In another embodiment, the operator control unit 20 projects the one or more visual images 50 onto a substrate remote from the operator control unit 20. In yet another embodiment, the operator control unit 20 projects the one or more visual images 50 onto a side of the locomotive 16.

In one particular embodiment of the method, the operator control unit 20 comprises a substrate, e.g. display 80, associated with the operator control unit 20 and one or more selectively movable mirrors 78. In another embodiment, the method further comprises selectively positioning the one or more selectively movable mirrors 78 between a first position 86 and a second position 88. In the first position, the one or more selectively movable mirrors 78 is out of alignment with the one or more visual images 50 to display the image onto a substrate remote from the operator control unit 20. In the second position 88, the one or more selectively movable mirrors 78 deflect the one or more visual images 50 onto the substrate, e.g. display 80, associated with the operator control unit 20.

In yet another aspect of the present invention, as shown in FIG. 8, there is provided a method 200 for projecting information in a rail yard. The method 200 begins by transmitting 202 data representative of at least one of a first information and a second information from a dispatcher 38 to an off-board operator control unit 20 remote from the dispatcher 38. The dispatcher 38 has the first information stored in a memory therein and/or collects the second information from a source remote from the dispatcher 38. In addition, the dispatcher 38 comprises a processor and a transceiver. The method further comprises projecting 204 a visual representation of at least one of the first and second information from the operator control unit 20.

In an embodiment, at least one of the first and second information comprises information for regulation of switching activities in the rail yard 12. In another embodiment, the projecting 204 is done by an operator 22 holding the operator control unit 20 at a location remote from a locomotive 16 in the rail yard 12. In yet another embodiment, the transmitting 202 data further comprises determining a location of a locomotive 16 in the rail yard 12 and transmitting data to the operator control unit based on the determined location of the locomotive 16.

This written description uses examples to disclose embodiments of the invention, including the best mode, and also to enable any person skilled in the art to make and use the embodiments of the invention. The patentable scope of the embodiments of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

That which is claimed is:

1. A system for viewing information associated with a locomotive or other vehicle, comprising:
an imaging device configured to collect and transmit one or more visual images of a portion of the locomotive or other vehicle or an area surrounding the locomotive or other vehicle; and
an off-board operator control unit configured to receive the one or more visual images from the imaging device and comprising a projector configured to project the one or more visual images onto a substrate.

2. The system of claim 1, wherein said projector comprises a MEMS-based projector.

3. The system of claim 1, further comprising a dispatcher having a processor and a transceiver for relaying the one or more visual images from the imaging device to the operator control unit.

4. The system of claim 1, wherein said imaging device comprises a wayside video camera.

5. The system of claim 1, wherein the projector is disposed within a housing of the operator control unit.

6. The system of claim 1, wherein the projector is configured to project the one or more visual images onto a substrate remote from the operator control unit.

7. The system of claim 1, wherein the operator control unit further comprises a substrate associated with the operator control unit and one or more selectively movable mirrors, wherein the one or more selectively movable mirrors are movable from a first position wherein the one or more selectively movable mirrors is out of alignment with the one or more visual images to display the one or more visual images onto a substrate remote from the operator control unit and a second position wherein the one or more selectively movable mirrors deflects the one or more visual images onto the substrate associated with the operator control unit

8. A system for projecting information, comprising:
a dispatcher for storing information and/or obtaining information from an external source, said dispatcher comprising a processor and a transceiver; and
an off-board operator control unit for remote control of a locomotive or other vehicle, wherein the operator control unit is configured to receive the information sent from said transceiver and includes a projector configured to project the received information onto a substrate.

9. The system of claim 8, wherein the information comprises information for regulation of switching activities in a rail yard environment.

10. The system of claim 8, further comprising a display device located remote from the operator control unit for displaying images from the projector.

11. The system of claim 8, wherein said projector comprises a MEMS-based projector.

12. The system of claim 8, wherein the projector is disposed within a housing of the operator control unit.

13. A method for viewing information associated with a locomotive or other vehicle, comprising:
collecting one or more visual images of a portion of the locomotive or other vehicle or an area surrounding the locomotive or other vehicle;
transmitting the one or more visual images to an off-board operator control unit; and
projecting the one or more visual images from the operator control unit onto a substrate.

14. The method of claim 13, wherein the one or more visual images are collected from one or more cameras located on a portion of the locomotive or other vehicle.

15. The method of claim 13, wherein the one or more visual images are collected from a wayside camera.

16. The method of claim 13, wherein the projecting is performed by an operator holding the operator control unit at a location off-board from the locomotive or other vehicle.

17. The method of claim 13, wherein the operator control unit projects the one or more visual images onto a ground area adjacent an operator holding the operator control unit.

18. The method of claim 13, wherein the operator control unit projects the one or more visual images onto a substrate remote from the operator control unit.

19. The method of claim 13, wherein the operator control unit projects the one or more visual images onto a side of the locomotive.

20. The method of claim 13, further comprising:
selectively positioning one or more selectively movable mirrors between a first position and a second position, wherein the operator control unit comprises a substrate associated with the operator control unit and the one or more selectively movable mirrors, wherein in the first position the one or more selectively movable mirrors is out of alignment with the one or more visual images to display the image onto a substrate remote from the operator control unit and wherein in the second position the one or more selectively movable mirrors deflect the one or more visual images onto the substrate associated with the operator control unit.

21. A method for projecting information in a rail yard, comprising:
transmitting data representative of at least one of a first information and a second information from a dispatcher to an off-board operator control unit remote from the dispatcher, wherein the dispatcher has the first information stored in a memory therein and/or collects the second information from a source remote from the dispatcher, said dispatcher comprising a processor and a transceiver; and
projecting a visual representation of at least one of the first and second information from the operator control unit.

22. The method of claim 21, wherein at least one of the first and second information comprises information for regulation of switching activities in the rail yard.

23. The method of claim 21, wherein the projecting is done by an operator holding the operator control unit at a location remote from a locomotive in the rail yard.

24. The method of claim 21, wherein the transmitting data further comprises:
determining a location of a locomotive in the rail yard; and
transmitting data to the operator control unit based on the determined location of the locomotive.
